(19) United States
(12) Patent Application Publication
(10) Pub. No.: US 2021/0182746 A1
(43) Pub. Date: Jun. 17, 2021

(54) SYSTEMS AND METHODS FOR DIGITIZING BUSINESS TRANSACTIONS AND GENERATING ELECTRONIC DISPLAYS OF ACTIONABLE INSIGHTS

(71) Applicant: Honeywell International Inc., Morris Plains, NJ (US)

(72) Inventor: Sathish MUTHUKRISHNAN, Phoenix, AZ (US)

(21) Appl. No.: 16/713,905

(22) Filed: Dec. 13, 2019

(51) Int. Cl. G06Q 10/06; G06N 20/00; G06F 16/93

(52) U.S. Cl. CPC G06Q 10/067; G06F 16/93; G06Q 10/0637; G06N 20/00

(57) ABSTRACT

Disclosed are systems and methods for digitizing business transactions and generating electronic displays of actionable insights is disclosed. A method may include: receiving, by a processor through a network, data related to one or more parts or products associated with an enterprise business unit from one or more databases in one or more formats; translating, by the processor, the received data into a single common format; identifying, by the processor, patterns in the translated data related to insights of the one or more parts or products; generating, by the processor, actionable insights based on the identified patterns; generating, by the processor, one or more reports based on the generated actionable insights; and displaying, by the processor, the generated reports on a single user interface of a user device through the network.

### TECHNICAL FIELD

Various embodiments of the present disclosure generally relate to digitizing data of business transactions and, more particularly, to systems and methods for digitizing business transactions and generating electronic displays of actionable insights.

### BACKGROUND

Enterprise businesses utilize a number of processes, or transactions, for the production, manufacturing, sale, and/or distribution of goods or services. For example, enterprise businesses may include various enterprise business units that each perform business and/or manufacturing functions or transactions of the enterprise business. Employees of the enterprise business units, such as general managers, may require performance information relating to some business and manufacturing transaction of the enterprise business unit to improve strategic and tactical decisions. However, each business and manufacturing transaction of an enterprise business unit may include different types of data sources that may include different types of data formats. Further, certain aspects of some business and manufacturing transactions may be analog, and performed manually. Accordingly, it may be difficult to digitize, automate, and/or generate displays of actionable insights for certain types of business and manufacturing transactions, function, and/or processes.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for digitizing business transactions and generating electronic displays of actionable insights.

In one embodiment, a computer-implemented method for digitizing business transactions and generating electronic displays of actionable insights is disclosed. The method may include: receiving, by a processor through a network, data related to one or more parts or products associated with an enterprise business unit from one or more databases in one or more formats; translating, by the processor, the received data into a single common format; identifying, by the processor, patterns in the translated data related to insights of the one or more parts or products; generating, by the processor, actionable insights based on the identified patterns; generating, by the processor, one or more reports based on the generated actionable insights; and displaying, by the processor, the generated reports on a single user interface of a user device through the network.

In another embodiment, a computer system for digitizing business transactions and generating electronic displays of actionable insights is disclosed. The computer system may include: a memory having processor-readable instructions stored therein; and at least one processor configured to access the memory and execute the processor-readable instructions, which when executed by the processor configures the processor to perform a plurality of functions, including functions for: receiving, through a network, data related to one or more parts or products associated with an enterprise business unit from one or more databases in one or more formats; translating the received data into a single common format; identifying patterns in the translated data related to insights of the one or more parts or products; generating actionable insights based on the identified patterns; generating one or more reports based on the generated actionable insights; and displaying the generated reports on a single user interface of a user device through the network.

In yet another embodiment, a non-transitory computer-readable medium containing instructions for digitizing business transactions and generating electronic displays of actionable insights is disclosed. The non-transitory computer-readable medium may include instructions for: receiving, by a processor through a network, data related to one or more parts or products associated with an enterprise business unit from one or more databases in one or more formats; translating, by the processor, the received data into a single common format; identifying, by the processor, patterns in the translated data related to insights of the one or more parts or products; generating, by the processor, actionable insights based on the identified patterns; generating, by the processor, one or more reports based on the generated actionable insights; and displaying, by the processor, the generated reports on a single user interface of a user device through the network.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system environment for digitizing business transactions and generating electronic displays of actionable insights, according to one or more embodiments.

FIG. 2 depicts a flowchart of a method for digitizing business transactions and generating electronic displays of actionable insights, according to one or more embodiments.

FIG. 3 depicts an exemplary view of a display of reports and actionable insights generated using the system environment of FIG. 1.

FIG. 4 depicts an example system that may execute techniques presented herein.

### DETAILED DESCRIPTION OF EMBODIMENTS

In the following description, embodiments will be described with reference to the accompanying drawings. The terminology used in this disclosure may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a” and “an” include plural referents unless the context dictates otherwise. The term “exemplary” is used in the sense of “example” rather than “ideal.” The terms “information,” “data,” and “content” may be interchangeable when permitted by context. The terms “record” and “store,” in the sense of recording or storing data, may be interchangeable when permitted by context. The terms “comprises,” “comprising,” “includes,” “including,” and other variations thereof, are intended to cover a non-exclusive inclusion such that a process, method, or product that comprises a list of elements does not necessarily include only those elements, but may include other elements not expressly listed or inherent to such a process, method, article, or apparatus.

In general, systems and methods are disclosed for digitizing business transactions and generating electronic displays of actionable insights. As used herein, “business transactions” may include any type of task or activity, and/or collection of tasks or activities, for delivery of goods, services, or products, that utilize various types of data for completing the tasks and/or activities. For example, business transactions may include equipment, computer systems, and/or databases, for generating, receiving, and/or outputting the data and performing the tasks and/or activities. Business transactions may also include manufacturing transactions for the production of goods or services. As detailed above, it may be difficult to digitize and automate certain business and manufacturing transactions or processes due to those business and manufacturing transactions relying on disparate data sources and various types of systems. Accordingly, the present disclosure provides for systems and methods to digitize business transactions according to a digital transformation framework. The digital transformation framework may include tenants for establishing and applying the framework to various business and manufacturing transactions, functions, and/or processes to digitize the business and manufacturing transactions. The tenants may include, for example, digitization, a digital thread, and digital transformation.

Digitization may include converting analog and manual transactions or processes to digital processes and creating data visibility into those digital transactions or processes. The digital thread may provide for interconnecting each step of the newly digitized transaction and generating electronic displays of those interdependencies. Digital transformation may include reimagining existing transactions or processes to be futuristic and flexible to anticipate customer demands, and create new business opportunities. Using the framework, the systems and methods provided herein may include digitizing various types of business and manufacturing transactions of an organization, such as an enterprise business.

Embodiments of the present disclosure may also provide a single platform for accessing and displaying real time data and actionable insights. As used herein, “actionable insights” are direct, meaningful actions that can be taken from analyzing any type of raw data. Actionable insights may be the result of data analytics that provides data for users to make well-informed decisions. The platform may provide a centralized location for accessing data, information, and/or actionable insights of the digitized business and manufacturing transactions. For example, the platform may provide real time data and actionable insights for self service, automated reports to the decision enablers. The systems and methods may provide continuous monitoring and generate proactive alerts and customized triggers for personalized notifications. The systems and methods may include closed loop systemic actions. For example, the platform may be self healing and machine driven for continuous improvement. The platform may integrate numerous types of systems to provide common, connected, and consistent processes. The platform may enable organic growth of the business by providing a holistic customer and business view and offering a digitally competitive operating model.

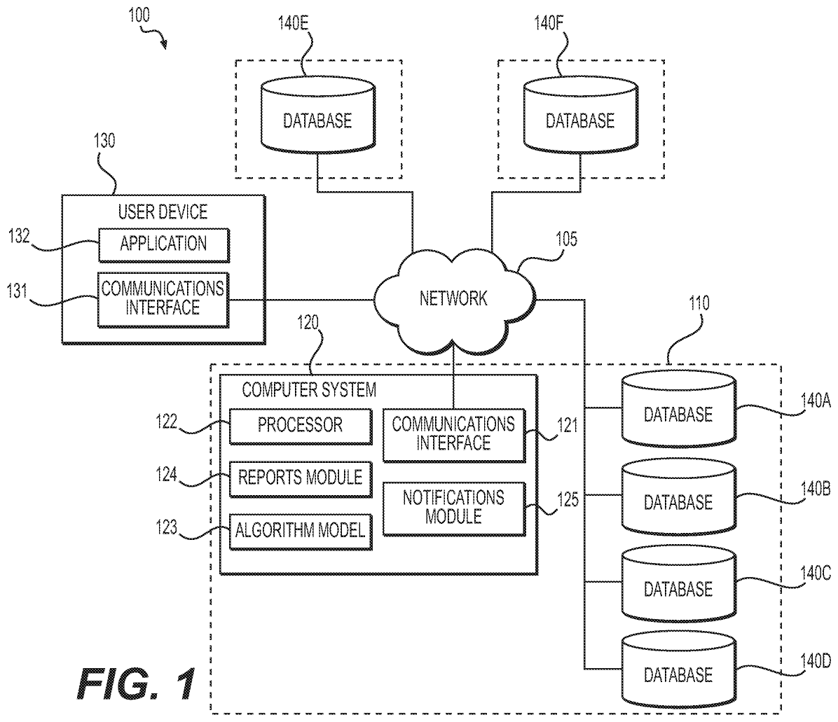

Referring now to the appended drawings, FIG. 1 illustrates an exemplary system environment 100 for digitizing business transactions and generating electronic displays of actionable insights, according to the present disclosure. System environment 100 may include a computer system 120 of a host organization 110, a user device 130, and one or more databases 140A-140F connected to one another via a network 105, such as the Internet. The host organization 110 may be any type of organization having company-wide business and manufacturing transactions for the production, sale, and/or distribution of goods or services. For example, the host organization 110 may include an aerospace company that produces, manufactures, and/or trades (e.g., sells) aerospace products, such as aircraft parts. The host organization 110 may include various enterprise business units that each perform one or more business and/or manufacturing transactions, processes, and/or functions.

The one or more databases 140A-140F may include one or more databases that store data related to the business and manufacturing transactions of host organization 110. The one or more databases 140A-140F may store, for example, data related to one or more products of the host organization 110. As used herein, “products” may include any type of product, good, service, or technology. The one or more databases 140A-140F may include internal databases hosted by host organization 110, such as pricing databases 140A, marketing databases 140B, research, development, and engineering (RDE) databases 140C, and/or inventory databases 140D. The one or more databases 140A-140F may also include external databases hosted by organizations external of host organization 110, such as supplier databases 140E, and/or sales force databases 140F. The databases 140A-140F may include disparate sources of data and/or information and may be included in separate (e.g., non-integrated) systems, databases, and/or data warehouses. For example, the one or more databases 140A-140F may include different types of data stored in one or more formats. The one or more formats of the data may include different types of formats. It is understood that the one or more databases 140A-140F may include any type of database (e.g., internal and/or external) for storing any type of information relating to the business and manufacturing processes of host organization 110 and may include any number of databases. Further, any of the one or more databases 140A-140F may be internal or external databases.

Pricing databases 140A may include one or more databases for storing data and/or information related to pricing of the one or more products. For example, pricing databases 140A may include pricing for the one or more products determined based on market analysis and product differentiation. The pricing databases 140A may also include internal marketing documents, such as green sheets, that are compiled by host organization 110 for determining pricing of the one or more products. The pricing databases 140A may also include price plan information, price comparison information, actual pricing information. Further, the pricing databases 140A may each store different types of data related to pricing and/or may store the data in one or more different types of formats.

Marketing databases 140B may include one or more databases for storing data and/or information related to marketing of the one or more products. For example, marketing databases 140B may include incentive information for selling the one or more products, such as sales prices, merchandise credit vouchers, or any other type of incentive. Marketing databases 140B may also include external sources (e.g., through network 105) of data related to price comparisons of the one or more products. It is understood that marketing databases 140B may include any type of data and/information related to marketing. Further, the marketing databases 140B may each store different types of data related to marketing and/or may store the data in one or more different types of formats.

RDE databases 140C may include one or more databases for storing data and/or information related to metrics for evaluating RDE performance. For example, the metrics may include initial cost of a RDE program, current cost of the RDE program, target cost of the RDE program, and amount funded for the RDE program. It is understood that the RDE databases 140C may include any type of data and/or information relating to metrics of RDE performance. Further, the RDE databases 140C may each store different types of data related to RDE performance metrics and/or may store the data in one or more different types of formats.

Inventory databases 140D may include one or more databases for storing data and/or information related to inventory and/or materials of the host organization 110. The inventory may include the one or more products. For example, the inventory databases 140D may include inventory of parts, materials, and/or products of host organization 110. The inventory databases 140D may also include information from supplier databases 140E, such as supplier inventory data and/or information, as detailed below. The inventory databases 140D may also include information of inventory allocation to a plurality of users, as detailed below. It is understood that inventory databases 140D may include any type of data and/or information relating to inventory of the host organization and/or of the suppliers. Further, the inventory databases 140D may each store different types of data related to inventory and/or materials of the host organization 110 and/or may store the data in one or more different types of formats.

Supplier databases 140E may be associated with a supplier. The supplier may supply parts, products, and/or materials to host organization 110 for generating parts, products, and/or materials. Supplier databases 140E may include one or more databases for storing data and/or information related to metrics for evaluating supplier performance. The metrics may include, for example, delivery information, producibility information, and/or speed information. The supplier databases 140E may also include one or more databases for storing data and/or information related to supplier inventory of the supplier. For example, the supplier inventory may include inventory levels of parts, products, and/or materials of the supplier. It is understood that supplier databases 140E may include any type of data and/or information related to metrics for evaluating supplier performance and/or supplier inventory. Further, system environment 100 may include more than one supplier each having their own supplier databases 140E. As such, the supplier databases 140E may store different types of data related to metrics and/or may stored the data in one or more different types of formats.

Sales force databases 140F may include one or more databases for storing data and/or information related to sales force metrics of host organization 110. For example, the sales force may include one or more sales teams of host organization 110. The sales force metrics of sales force databases 140F may include customer needs, requirements, and/or pain points information, customer order information, sales agreement and/or contract information, purchase order information, or any other information related to the sales force metrics of the host organization 110. Sales force databases 140F may also include data and/or information related to current install information of parts, products, and/or materials installed on customer components. It is understood that sales force databases 140F may include any type of data and/or information related to a sales force of host organization 110. Further, the sales force databases 140F may each store different types of data related to sales force metrics of the host organization 110 and/or may store the data in one or more different types of formats.

The computer system 120 of host organization 110 may include a memory, one or more processors, communication interfaces, input devices, and output devices. Computer system 120 may include one or more communication interfaces 121. Communication interface 121 may include one or more cellular radios, Bluetooth, WiFi, near-field communication radios, or other appropriate communication devices for transmitting and receiving information. As can be seen in FIG. 1, communication interface 121 facilitates communication between computing system 120 and network 105. Multiple communication interfaces 121 may be included in computing system 120 for providing multiple forms of communication between computer system 120 and databases 140A-140F and user device 130 via network 105. For example, communication may be achieved with network 105 through wireless communication (e.g., WiFi, radio communication, etc.) and/or a wired data connection (e.g., a universal serial bus, an onboard diagnostic system, etc.) or other communication modes.

Computer system 120 may also include one or more processors and a memory for storing and executing applications or software modules of system environment 100. The one or more processors may be configured to access the memory and execute processor-readable instructions, which when executed by the processor configures the processor to perform a plurality of functions of the system environment 100. For example, the one or more processors may include one or more processors 122 for digitizing analog business processes and generating actionable insights, as detailed further below.

The computer system 120 may further include one or more modules and/or models including an algorithm model 123, a reports module 124, and a notifications module 125, which may be software components stored in/by the computer system 120 (e.g., stored on the memory). The computer system 120 may be configured to utilize the one or more module and/or models when performing various methods described in this disclosure. For example, processor 122 may execute reports module 124 to generate and output one or more reports based on generated actionable insights, as detailed below. Further, processor 122 may execute notifications module 125 to generate and output one or more alerts based on the generated actionable insights and/or based on the raw data from databases 140A-140F, as detailed below. In some embodiments, computer system 120 may have a cloud computing platform with scalable resources for computation and/or data storage, and may run on or more applications on the cloud computing platform to perform various computer-implemented methods described in this disclosure. In some embodiments, some of the modules and/or models may be combined to form fewer modules and/or models. In some embodiments, some of the modules and/or models may be separated into separate, more numerous modules and/or models. In some embodiments, some of the modules and/or models may be removed while others may be added.

Computer system 120 may be configured to receive data from other components (e.g., databases 140A-140F) of system environment 100 via network 105. Computer system 120 may further be configured to utilize the received data by inputting the received data into the algorithm model 123 to produce a result. Information indicating the result may be transmitted to user computing device 130 over network 105. In some embodiments, the computer system 120 may be referred to as a server system that provides a service including providing the information indicating the received data and/or the result to the user computing device 130.

The algorithm model 123 may be a plurality of algorithm models. The algorithm model 123 may include a trained machine learning algorithm. The trained machine learning algorithm may include a regression-based model that accepts data from databases 140A-140F as input data. The trained machine learning algorithm may be part of the algorithm model 123. The trained machine learning algorithm may be of any suitable form, and may include, for example, a neural network. A neural network may be software representing human neural system (e.g., cognitive system). A neural network may include a series of layers termed “neurons” or “nodes.” A neural network may comprise an input layer, to which data is presented; one or more internal layers; and an output layer. The number of neurons in each layer may be related to the complexity of a problem to be solved. Input neurons may receive data being presented and then transmit the data to the first internal layer through connections' weight. A neural network may include a convolutional neural network, a deep neural network, or a recurrent neural network. The machine learning algorithm may be trained by supervised, unsupervised or semi-supervised learning using training sets comprising data of types similar to the type of data used as the model input.

User device 130 may include a computer system, such as a personal computer, handheld device, or other type of computer system used by one or more users, such as a first user. As such, user device 130 may include a memory, one or more processors, communication interfaces, input devices, and output devices. User device 130 may include one or more communication interfaces 131. Communication interface 131 may include one or more cellular radios, Bluetooth, WiFi, near-field communication radios, or other appropriate communication devices for transmitting and receiving information. As can be seen in FIG. 1, communication interface 131 facilitates communication between user device 130 and network 105. Multiple communication interfaces 131 may be included in user device 130 for providing multiple forms of communication between user device 130 and computer system 120 and/or databases 140A-140F via network 105. For example, communication may be achieved with network 105 through wireless communication (e.g., WiFi, radio communication, etc.) and/or a wired data connection (e.g., a universal serial bus, an onboard diagnostic system, etc.) or other communication modes.

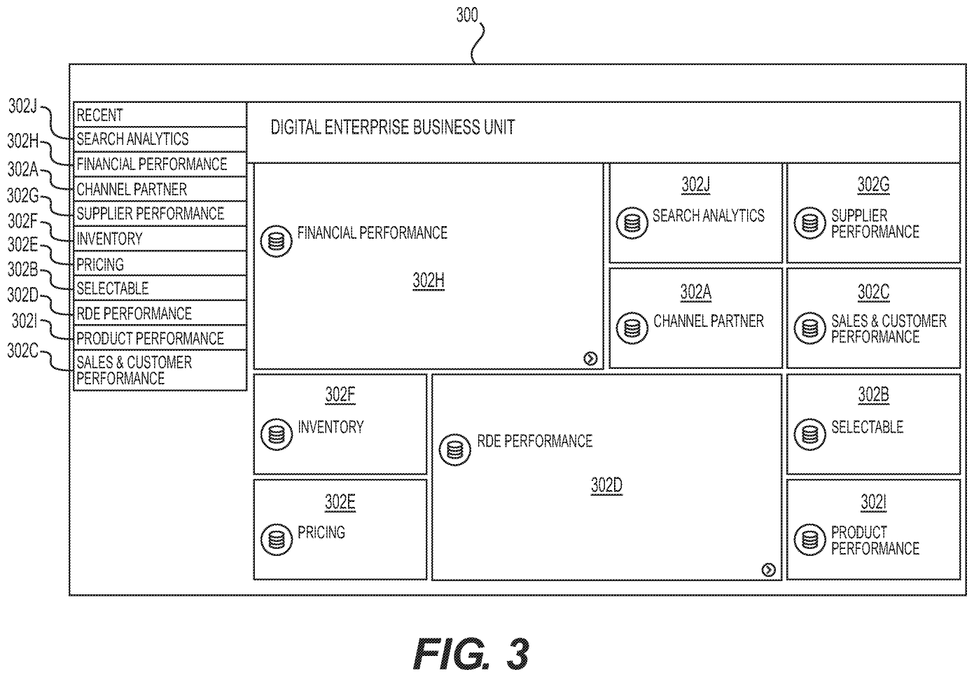

User device 130 may also include an application, such as a web browser application or the like, for accessing an application of host organization 110 via network 105. The application of host organization 110 may provide a platform and interface 300 (FIG. 3) for the first user for displaying generated reports and receiving generated alerts, as detailed below. The first user may be an employee of host organization 110, such as a manager, general manager, or the like. One or more products of host organization 110 may be associated with enterprise business unit and/or the first user. For example, the first user may oversee one or more teams, such as an enterprise business unit, of host organization 110 and one or more products of inventory of host organization 110 may be associated with the enterprise business unit and/or the first user. The first user may also be associated with one or more of the business and/or manufacturing transactions of host organization 110. Accordingly, processor 122 may implement a method 200 for digitizing business transactions and generating actionable insights for first user, as detailed further below.

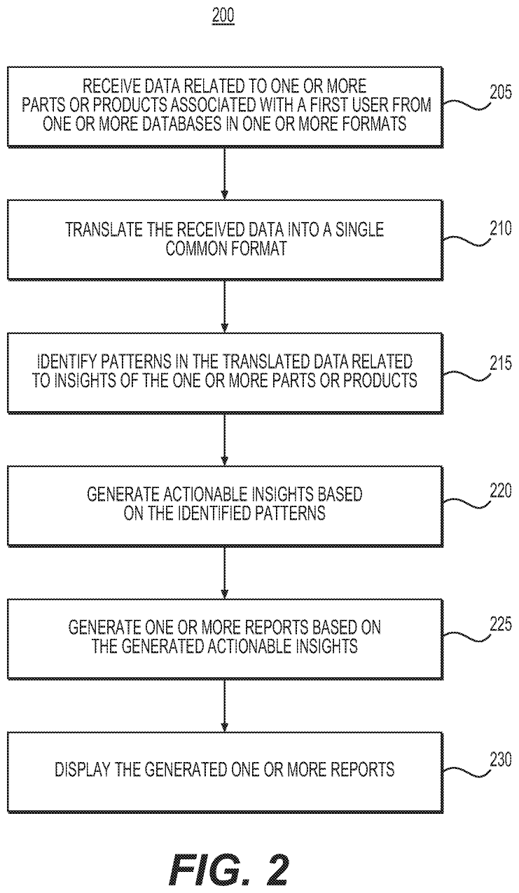

FIG. 2 is a flowchart of a method 200 for digitizing business transactions and generating actionable insights, according to one or more embodiments. In an initial step 205, processor 122 may receive, through network 105, data related to one or more parts or products associated with an enterprise business unit from one or more databases 140A-140F in one or more formats. For example, the one or more databases 140A-140F may include one or more databases including different types of data. The one or more databases 140A-140F may also include one or more databases each storing data in a different format. In step 210, processor 122 may translate the received data into a single common format. The processor 122 may generate a common repository for storing the translated data in the common repository. For example, the common repository may include a single data warehouse for compiling the different types of data from the one or more databases 140A-140F. It is understood that the single data warehouse may include one or more data warehouses for compiling and storing the different types of data.

In step 215, processor 122 may identify patterns in the translated data related to insights of the one or more parts or products. In step 220, processor 122 may generate actionable insights based on the identified patterns. The processor 122 may predict one or more metrics corresponding to the one or more products, as detailed below. For example, processor 122 may generate analytics of the one or more products of the enterprise business unit based on the predicted one or more metrics. In one embodiment, the processor 122 may train algorithm model 123 (e.g., a machine learning algorithm) to receive the data, identify patterns in the translated data, and predict the one or more metrics to provide analytics via interface 300, as detailed below.

In step 225, processor 122 may generate one or more reports based on the generated actionable insights. In step 230, processor 122 may display the generated one or more reports via interface 300 (FIG. 3) on user device 130 through the network 105. As new data is received, the processor 122 may update the generated actionable insights and may generate one or more new reports accordingly. The updating may be triggered by a predetermined threshold. For example, the predetermined threshold may correspond to receiving a certain amount of data, an amount of time elapsed since a previous update, and/or at a set time. It is understood that the updating may be triggered by any means.

The processor 122 may also output one or more alerts based on the received data. For example, the processor 122 may compare the identified patterns in the translated data to one or more predetermined thresholds. The predetermined thresholds may include thresholds for one or more metrics corresponding to the one or more products. The predetermined thresholds may be set by user input. Based on the comparing, the processor 122 may generate one or more alerts and output the one or more alerts. For example, the one or more alerts may be displayed via platform 300 described with respect to FIG. 3 below. The one or more alerts may also include e-mail notifications, text notifications, or any type of alert.

FIG. 3 is an exemplary view of an electronic display of an interface 300 of reports and actionable insights generated using the system environment 100. Interface 300 may include a platform implemented and hosted by host organization 110 for presenting and displaying the generated actionable insight and reports generated by the method 200, detailed above. Accordingly, interface 300 may provide a single platform for presenting data related to the one or more parts or products associated with the enterprise business unit. For example, interface 300 may provide a user interface corresponding to the digitization, digital thread, and digital transformation of one or more business and/or manufacturing transactions. For example, digitization may include processor 122 identifying and consolidating all data sources from, for example, the one or more databases 140A-140F. Digitization may also include ensuring that all required data sources are digital. Further, digitization of business and manufacturing transactions may provide a data visualization tool (e.g., interface 300) for fast analytical and rapid business intelligence. Processor 122 may automatically process raw data (e.g., from databases 140A-140F) and generate operational metrics of the raw data, such as actionable insights.

The digital thread of the interface 300 may include processor 122 aggregating all data (e.g., into a data warehouse) into a useable interface 300. Processor 122 may generate one or more templates for reporting the actionable insights based on the one or more metrics. The metrics may include, for example, metrics for measuring and/or evaluating enterprise business performance including product health, short range outlook, business key performance indicators (KPI), new product introduction (NPI), vitality, breakthrough growth, or any other type of metric for evaluating performance of the enterprise business. The digital thread of the interface 300 may also enable automated alerts and notifications for enterprise business operational KPIs, such as on time to receipt (OTTR), rolled throughout yield (RTY), project portfolio management (PPM), or the like. Digital thread may further include implementing multi-dimensional views on the interface 300, such as a product view, customer view, platform, etc.) to make strategic and tactical decisions.

The digital transformation tenant of the interface 300 may include connecting the customer, product, platform, and finance systems to provide real time insights of the enterprise business financial, operational, quality, and performance indicators. Further, the interface 300 may provide access to key capabilities that will enable enterprise business leaders to land in one location and see key reports and applications to run the enterprise business unit.

The interface 300 may provided a centralized digital interface that pulls stranded data automatically for all enterprise business units of host organization 110. The interface 300 may include pre-defined views to drive strategic enterprise business actions. Financials may be linked to the interface 300 for improved pricing visibility and decision making. The interface may provide for improved RDE performance and traceability, manufacturing visibility, and inventory visibility. The interface 300 may also provide for a proactive view of when customers have issues and may provide views for supplier OTTR performance visibility and supplier forecast visibility.

As shown in FIG. 3, the exemplary interface 300 may include one or more modules 302A-302J executed by processor 122 and displayed, for example, on user device 130. The one or more modules 302A-302J may include actionable insights and reports generated by method 200 for each module 302A-302J by applying the digitization framework to each respective business and manufacturing transaction associated with the modules 302A-302J. For example, the modules 302A-302J may include a channel partner module 302A, a selectables module 302B, a sales/customer performance module 302C, a RDE performance module 302D, a pricing module 302E, an inventory module 302F, a supplier performance module 302G, a financial performance module 302H, a product performance module 302I, and/or a search analytics module 302J. Each module 302A-302J may be generated and implemented by the digitalization, digital thread, and digital transformation of a business and/or manufacturing transactions of host organization 110. Accordingly, the modules 302A-302J include digitized business transactions and generated actionable insights. It is understood that the modules 302A-302J detailed herein are exemplary only and modules 302A-302J may include any type of module including actionable insights and reports related to business and manufacturing transactions and may include any number of modules. Further interface 300 may present and display the insights and reports by different interfaces other than modules and may include any type of interface for presenting and displaying the insights and reports.

Channel partner module 302A may provide data, reports, and/or insights into channel partners of host organization 110. Channel partners may include external organizations that partner with host organization 110 to market and sell the one or more products, services and/or technologies of host organization 110. The channel partner module 302A may map 1-to-1 channel partner account to sales force sold to account. The channel partner module 302A may automate data submission into a centralized database for improved reporting and predictive analytics capability (e.g., via method 200). The digitization tenant of the channel partner module 302A may include capturing opportunities, owners, actions, and results all in a single location. The digital thread of the channel partner module 302A may include improving the sales and channel partner process by using captured data to ensure that the enterprise business maximizes profits. The digital transformation tenant for the channel partner module 302A may provide a seamless integration of enterprise business leadership, sales teams, and channel partners to make more intelligent management decisions and improve financials.

Selectables module 302B may provide visibility into what is sold by a sales team as it is sold. As used herein, “selectables” may include sales incentives, such as sales prices, discounts, merchandise credit vouchers, or any other type of incentive, and whether those incentives are applied (e.g., selected) for a given transaction. Selectables module 302B may provide tracking on the enterprise business unit's costs tied to sales (e.g., MCV's, discounts, and other incentives). The selectables modules 302B may provide sales team visibility into what has already been sold and real time upsell opportunities. Regional comparisons on sales and incentives may also be provided. Accordingly, selectables module 302B may provide improved consistency from sales teams.

The digitization tenant of the framework for the selectables module 302B may include automating sales team data capture (e.g., via method 200). For example, processor 122 may create and improve a central repository of products and pricing. The actionable insights may include incentives budgeting and tracking. For example, the selectables module 302B may digitize how incentives are offered (e.g., selected or not). The digital thread tenant for the selectables module 302B may standardize deal negotiation and integrate sales and incentives with enterprise business financials. Further, the digital thread may include aggregating and processing all data (e.g., in a data warehouse) and applying algorithm model 123 (e.g., machine learning algorithm) for financial forecasting and insights that apply regionally, by customer, product family, or globally. The digital transformation tenant for the selectables module 302B may provide seamless integration of customer engagement, deal negotiation, and financials driven through predictive analytics.

The selectables module 302B may further provide automated report generation including reports generated directly from the source. Accordingly, the selectables module 302B may reduce cycle time to identify key sales opportunities, digitize how incentives are offered, and apply machine learning to better predict opportunity space. The selectables module 302B may also provide various analytics (e.g., based on one or more metrics), such as match win/loss by product, platform, or customer, cross check with order book for win/loss ratio, adjustments to record equipage per customer, and/or standard sales playbook for deal negotiation.

Sales/customer performance module 302C may provide increased visibility into customer requirements, such as “pain points” (e.g., key drivers), to develop a good strategy for sales. The sales/customer performance module 302C may enable the enterprise business to align NPI product roadmap and tie to sales force customer opportunities and leads. Further, the sales/customer performance module 302C may provide a short range outlook output from sales, inventory, and operations planning (SIOP) including sales per firm orders. The sales/customer performance module 302C may provide improved sales opportunities by sales teams knowing what products are installed on customer products (e.g. repair, modification, upgrades) and what upsell opportunities exist.

The digitization tenant of the framework for the sales/customer performance module 302C may include capturing leads and opportunities by customer, as well as providing a full view of the product line. The digital thread tenant may include an enterprise business product line thread across multiple platforms that are tied to the enterprise business unit so the enterprise business unit can target white space opportunity. The digital transformation tenant of the sales/customer performance module 302C may include building artificial intelligence into the sales force to identify opportunity that should be in the short range outlook for SIOP prior to a purchase order (e.g., via method 200). For example, the artificial intelligence may identify which opportunities are likely to close in time to support accurate short range outlook in SIOP forecasting. The sales/customer performance module 302C may provide analytics based on one or more metrics, such as sales force wave analytics and primary analytics and reporting. Accordingly, the sales/customer performance module 302C may support self-service by the enterprise business to look at products specific to that enterprise business. The sales/customer performance module 302C may provide insights into entitlements, identifies product numbers, and provide global views.

RDE performance module 302D may provide standardized research, development, and engineering performance visibility for RDE to spend decisions by the enterprise business unit. RDE performance module 302D may also provide monthly investment trend changes at enterprise business unit level, drilled down to program level. Further, the RDE performance module 302D may provide on demand tracking of every change in investment, as well as automated alerts and notifications (e.g., via method 200) on target versus actual. The RDE performance module 302D may further provide improved control over RDE cost drivers and improved speed to market to customers.

The digitization tenant of the framework for the RDE performance module 302D may include an RDE baseline against annual operations plan (AOP). Further, RDE performance module 302D may provide change control with approval workflows and score cards with monthly snapshots and trends (e.g., via method 200). The digital thread tenant for RDE performance module 302D may include providing alerts at a predetermined threshold (e.g., a percentage) change at program level and alerts on AOP variation over approved AOP. The RDE performance module 302D may predict year to date (YTD) performance and provide closed loop control on alerts. The digital transformation tenant for RDE performance module 302D may include key code level cost roll up to program across time, material, and contracts and may provide actual revenue versus RDE cost.

The RDE performance module 302D may provide a single window into key RDE related performance metrics. Further, the RDE performance module 302D may provide exception based (e.g., red, yellow, green) reporting that directs user focus to critical areas that need their immediate attention. The RDE performance module 302D may include a summary level dashboard with drilldown capabilities. The RDE performance module 302D may enable managers to take proactive action on urgent issues and prevent program misses and cost overspends.

Pricing module 302E may provide data drive pricing decisions in one location and may track market conditions to drive improved pricing decisions (e.g., via method 200). For example, pricing module 302E may include MCV visibility and tracking, as well as visibility into which customers, platforms, and products are already sold to maximize shareholder value (e.g., intelligent MCV's, pricing, etc.). Accordingly, customers may receive consistent pricing from the enterprise business.

The digitization tenant of the framework for pricing module 302E may include identifying and consolidating all data sources (e.g., via method 200). The pricing module 302E may ensure all required data sources are digital and also ensure new green sheets are digitized along with all other data sources. Accordingly, pricing module 302E may automatically gather and process the raw data to create usable information (e.g., via method 200). The digital thread tenant for pricing module 302E may include aggregating and processing all data (e.g., data warehouse), applying the algorithm model 123 (e.g., machine learning) to pricing and customer data, and implementing multi-dimensional views to make strategic and tactical decisions with respect to pricing of the one or more products. The digital transformation tenant for pricing module 302E may include digitizing and transforming the non-digital (e.g., analog) pricing process to provide real time insights into pricing and sales decisions that maximize shareholder value by looking at the end to end value stream.

Pricing module 302E may provide for various analytics. For example, pricing module 302E may include a sales analytics mix, a price measurement metric, and a living green sheet. The sale analytics mix may include pricing module 302E (e.g., via processor 122) providing a margin comparison on products and identifying opportunity for margin improvements. The price measurement metric may include pricing module 302E identifying true actual pricing and measuring deviation to plan. The living green sheet may include pricing module 302E providing improved visibility to the price plan and a flow down for price comparison.

Accordingly, pricing module 302E may provide a self service tool on interface 300 that provides a view into the product performance on margin with respect to revenue. The pricing module 302E may provide descriptive analytics based on the price and margin comparison on similar products and services and provide the margin comparison between several customers (e.g., via method 200). As such, pricing module 302E may help to review and identify margin opportunity for products based on the comparative analytics. The pricing module 302E may further provide at-a-glance potential opportunities for underperforming products and customers. Further, pricing module 302E may also enable self-service capability to drill down into specific analysis based on revenue segment and enterprise business. For example, the data presented may include customer and transactional detail such as discounts and total cost. Thus, the pricing module 302E may enable teams of host organization 110 to understand opportunities on price, discount, and/or cost for the one or more products.

Inventory module 302F may include enterprise business unit visibility into inventory tied to spares and customer orders. For example, inventory module 302F may provide improved sales opportunities by providing information to sales teams corresponding to what products are available and what products could be quickly available. Further, inventory module 302F may provide improved OTTR and customer satisfaction, as well as visibility into suppliers' inventory levels.

The digitization tenant of the framework for inventory module 302F may include building and improving enterprise business unit reporting to capture real time opportunities. Further, inventory module 302F may provide a review option to collect supplier inventor levels for enterprise business unit critical materials. The digital thread tenant for inventory module 302F may tie inventory levels to forecasted customer demand in one easy to use tool for enterprise business leadership. Further, the enterprise business unit may utilize inventory visibility module 302F to drive improved sales including pricing and selectables opportunities. The inventory module 302F may automatically flag slow/no moving inventory for enterprise business unit review. The digital transformation tenant for inventory module 302F may include a seamless integration of enterprise business unit leadership, ISC, sales teams, suppliers, and customer engagement to enable more intelligent inventory decisions, improve financials, and improve customer satisfaction.

The inventory module 302F may assign parts to an enterprise business unit based on highest use of the material. For example, the inventory module 302F may provide visibility into all products or parts that populate into an enterprise business unit dashboard for the enterprise business unit, as well as financials so the enterprise business unit may proactively work to optimize the inventory strategy.

Supplier performance module 302G may provide visibility to supplier performance indicators and provide awareness of signal and forecast data that is sent to suppliers of the host organization 110 (e.g., via method 200). Further, the supplier performance module 302G may provide improved visibility for factories and planners, may help to reduce stranded inventory, and may reduce volatility. The supplier performance module 302G may provide improved customer OTTR. For example, supplier performance module 302G may help to provide parts or products on time to enable building and/or shipping per customer OTTR commitment. The supplier performance module 302G may further enable accurate forecasting based on ensuring all demand is correctly placed in the system and master data is correct (e.g., via method 200). Accordingly, supplier performance module 302G may improve supplier's visibility into drivers for OTTR so suppliers may improve performance.

The digitization tenant of the framework for supplier performance module 302G may include standardizing end to end supplier view by providing visibility to supplier performance indicators (e.g., via method 200). Further, supplier performance module 302G may enable accurate supplier forecasting, such as demands, orders, or the like. The supplier performance module 302G may enable intelligent manufacture and/or buy decisions and may track financials, such as supplier dues. The digital thread tenant for supplier performance module 302G may include aggregating all supplier performance data sources (e.g., from supplier databases 140E, customer databases, finance databases, etc.). The supplier performance module 302G may also assist in developing standard supplier templates for demand forecasting, delivery dates, footprint reductions, etc. Further, supplier performance module 302G may include intelligent views and alert mechanisms to track supplier dues. The digital transformation tenant for supplier performance module 302G may include connecting the supplier, customer, finance, and other data platforms to provide on demand supplier insights. Accordingly, supplier performance module 302G may provide a reliable tie of supplier metric information to an enterprise business unit level by enabling leaders to work with sourcing, procurement, quality, and other teams to improve delivery, producibility, and speed.

Financial performance module 302H may provide improved visibility into financial health of an enterprise business unit through consolidated real time views. For example, financial performance module 302H may provide a single source for metrics, profit and loss, working capital, free cash flow, AOP, and short range outlook. Accordingly, financial performance module 302H may increase awareness of available reports and views and provide actionable data (e.g., via method 200).

The digitization tenant of the framework for financial performance module 302H may provide for consolidating multiple data sources and views (e.g., into interface 300), enabling real time data for decision making, and enabling intelligent financial decisions. The digital thread tenant for financial performance module 302H may include connecting information to the financials, such as top line revenue and top customers with ability toy drill down. Further, financial performance module 302H may implement multi-dimensional views (e.g., product, customer, platform, etc.) for strategic decisions. The digital transformation tenant for financial performance module 302H may include connecting the customer, product, platform, and financials to provide real time insights of the enterprise business unit's financial indicators (e.g., via method 200).

The financial performance module 302H may enable leaders of the enterprise business unit to better understand the financial performance of the enterprise business unit throughout a time period (e.g., a month), as well as provide month end financial results. The month end financial results may include, for example, variable contribution margin (VCM), vitality, past due shipment data, daily sales and firming, and RDE data sets.

The product performance module 302I may provide improved visibility into performance of the one or more products associated with the enterprise business unit. The search analytics module 302J may provide a search engine tool for searching analytics generated by method 200.

Thus, the systems and methods of the present disclosure for digitizing business transactions and generating electronic displays of actionable insights may provide a comprehensive framework for digitizing enterprise business transactions, functions, and/or processes. The systems and methods may also create a digital thread to interconnect every step of the newly digitized transaction. Further, the systems and methods of the present disclosure may help to reimagine existing enterprise business transactions to be futuristic, flexible to anticipate customer needs, and create new business opportunities.

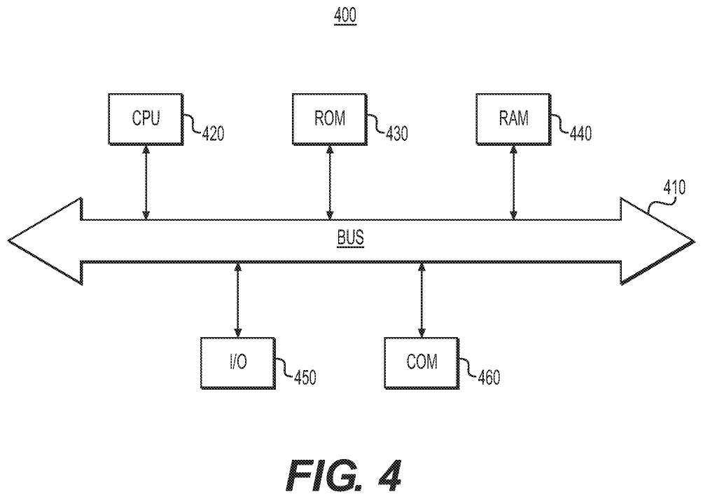

FIG. 4 depicts an example system that may execute techniques presented herein. FIG. 4 is a simplified functional block diagram of a computer that may be configured to execute techniques described herein, according to exemplary embodiments of the present disclosure. Specifically, the computer (or “platform” as it may not be a single physical computer infrastructure) may include a data communication interface 460 for packet data communication. The platform may also include a central processing unit (“CPU”) 420, in the form of one or more processors, for executing program instructions. The platform may include an internal communication bus 410, and the platform may also include a program storage and/or a data storage for various data files to be processed and/or communicated by the platform such as ROM 430 and RAM 440, although the system 400 may receive programming and data via network communications. The system 400 also may include input and output ports 450 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for digitizing business transactions and generating electronic displays of actionable insights, the method comprising:
receiving, by a processor through a network, data related to one or more parts or products associated with an enterprise business unit from one or more databases in one or more formats;
translating, by the processor, the received data into a single common format;
identifying, by the processor, patterns in the translated data related to insights of the one or more parts or products;
generating, by the processor, actionable insights based on the identified patterns;
generating, by the processor, one or more reports based on the generated actionable insights; and
displaying, by the processor, the generated reports on a single user interface of a user device through the network.

2. The computer-implemented method of claim 1, further comprising:
comparing, by the processor, the identified patterns in the translated data to one or more predetermined thresholds;
based on the comparing, generating, by the processor, one or more alerts; and
displaying, by the processor, the one or more alerts on the user device.

3. The computer-implemented method of claim 1, further comprising:
generating, by the processor, a common repository; and
storing, by the processor, the translated data in the common repository.

4. The computer-implemented method of claim 1, wherein at least one or more of the databases include different types of data.

5. The computer-implemented method of claim 4, wherein the at least one or more of the databases each store data in a different format.

6. The computer-implemented method of claim 1, wherein the generating, by the processor, the actionable insights based on the identified patterns includes: predicting, by the processor, one or more metrics corresponding to the one or more products.

7. The computer-implemented method of claim 6, wherein the predicting, by the processor, one or more metrics corresponding to the one or more products includes:
training, by the processor, a machine learning algorithm to identify the patterns in the translated data and predict the one or more metrics.

8. The computer-implemented method of claim 1, further comprising: updating, by the processor, the generated actionable insights and generating, by the processor, one or more new reports as new data is received.

9. A computer system for digitizing business transactions and generating electronic displays of actionable insights, comprising:
a memory having processor-readable instructions stored therein; and
at least one processor configured to access the memory and execute the processor-readable instructions, which when executed by the processor configures the processor to perform a plurality of functions, including functions for:
receiving, through a network, data related to one or more parts or products associated with an enterprise business unit from one or more databases in one or more formats;
translating the received data into a single common format;
identifying patterns in the translated data related to insights of the one or more parts or products;
generating actionable insights based on the identified patterns;
generating one or more reports based on the generated actionable insights; and
displaying the generated reports on a single user interface of a user device through the network.

10. The computer system of claim 9, further including functions for:
comparing the identified patterns in the translated data to one or more predetermined thresholds;
based on the comparing, generating one or more alerts; and
displaying the one or more alerts on the user device.

11. The computer system of claim 1, further including functions for:
generating a common repository; and
storing the translated data in the common repository.

12. The computer system of claim 9, wherein at least one or more of the databases include different types of data.

13. The computer system of claim 12, wherein the at least one or more of the databases each store data in a different format.

14. The computer system of claim 9, wherein the generating the actionable insights based on the identified patterns includes: predicting one or more metrics corresponding to the one or more products.

15. The computer system of claim 14, wherein the predicting one or more metrics corresponding to the one or more products includes:
training a machine learning algorithm to identify the patterns in the translated data and predict the one or more metrics.

16. The computer system of claim 9, further including functions for: updating the generated actionable insights and generating one or more new reports as new data is received.

17. A non-transitory computer-readable medium containing instructions for digitizing business transactions and generating electronic displays of actionable insights, comprising:
receiving, by a processor through a network, data related to one or more parts or products associated with an enterprise business unit from one or more databases in one or more formats;
translating, by the processor, the received data into a single common format;
identifying, by the processor, patterns in the translated data related to insights of the one or more parts or products;
generating, by the processor, actionable insights based on the identified patterns;
generating, by the processor, one or more reports based on the generated actionable insights; and
displaying, by the processor, the generated reports on a single user interface of a user device through the network.

18. The non-transitory computer-readable medium of claim 17, further comprising:
comparing, by the processor, the identified patterns in the translated data to one or more predetermined thresholds;
based on the comparing, generating, by the processor, one or more alerts; and
displaying, by the processor, the one or more alerts on the user device.

19. The non-transitory computer-readable medium of claim 17, further comprising:
generating, by the processor, a common repository; and
storing, by the processor, the translated data in the common repository.

20. The non-transitory computer-readable medium of claim 17, wherein at least one or more of the databases include different types of data.
